(19) United States
(12) Patent Application Publication
(10) Pub. No.: US 2007/0034749 A1
(43) Pub. Date: Feb. 15, 2007

(54) Deployable airfoil assembly for aircraft

(76) Inventor: Fred A. Wagner III, Charlotte, NC (US)

Correspondence Address: SCOTT T. GRIGGS, 901 MAIN STREET, SUITE 6300, DALLAS, TX, 75202, US

(21) Appl. No.: 11/202,494

(22) Filed: Aug. 12, 2005

(51) Int. Cl. B64C 3/54

(52) U.S. Cl. 244/218

(57) ABSTRACT

A deployable airfoil assembly is disclosed that provides for selectively augmenting lift surface area of an aircraft. In one embodiment, a fixed wing is mounted to the aircraft. An auxiliary wing is moveably coupled to the fixed wing and actuatable between a retracted position and an extended position. In the retracted position, the auxiliary wing is housed within the fixed wing and, in the extended position, the auxiliary wing is positioned above the fixed wing such that a venturi passageway is defined between the auxiliary wing and the fixed wing. A sail is deployable along a length of the auxiliary wing from a boom associated with the aircraft.

### TECHNICAL FIELD OF THE INVENTION

This invention relates, in general, to aircraft wing structures and, in particular, to a deployable airfoil assembly for a fixed wing aircraft that augments the lift surface area of the aircraft.

### BACKGROUND OF THE INVENTION

Short takeoff and landing, abbreviated STOL, refers to the ability of an aircraft to clear a 50-foot (15 meter) obstacle within 1500 feet (450 meters) of commencing takeoff, or in landing, to stop within 1500 feet (450 meters) after passing over a 50-foot (15 meter) obstacle. It is desirable under certain conditions for fixed-wing aircraft to be able to perform STOL operations at relatively low air speeds, for example, 20 to 30 knots (37-55 km/hr) indicated air speed. This requires either a high ratio of power to aircraft weight or high ratio of wing area to aircraft weight. Slats and flaps are the primary means for increasing the wing area of conventional aircraft. Typically, slats and flaps change the camber as well as increase the effective lift area of the wing. Increased wing area and changes in camber generally yield a greater lifting force on the wing, thereby reducing stall speed.

Another existing solution is described in U.S. Pat. No. 6,241,195 which issued in the name of Fred A. Wagner, III, (hereinafter “the '195 patent”). The '195 patent discloses a retractable airfoil assembly that augments the wing surface area of an aircraft enabling it fly without stalling at reduced speeds during takeoff and landing. The operation of the retractable airfoil assembly of the '195 patent is illustrated in prior art FIGS. 1-3.

With reference to FIG. 1, a prior art airfoil assembly 10 includes a flexible sail 12 that is retractably deployed along a airplane wing 14 via a track located at a leading edge 16. The flexible sail 12 and the airplane wing 14 form a continuous airfoil. In operation, stall zones 18 and 20 are created at the junction of the flexible sail 12 and the airplane wing 14 due to the difference in thickness therebetween. The stall zones 18 and 20 cause drag and less than optimum performance.

Referring now to FIG. 2, a prior art airfoil assembly 22 is illustrated having a flexible sail 24 interfacing a bottom surface of an airplane wing 26. Similar to FIG. 1, a stall zone 28 is created at the junction of the flexible sail 24 and the airplane wing 26 due to the difference in relative thicknesses of the wings at the junction. Referring now to FIG. 3, likewise, in a prior art airfoil assembly 30, in which an airfoil 32 is connected to an upper surface of an airplane wing 34, a stall zone 36 develops. Accordingly, regardless of the point of connection between the airfoil and the airplane wing, performance is not optimized due the presence of stall zones and related drag. Hence, a need exists for improvements to airfoil assemblies which augment the surface area of an aircraft without creating stall zones and drag.

### SUMMARY OF THE INVENTION

A deployable airfoil assembly is disclosed that provides for selectively augmenting lift surface area of an aircraft. In one embodiment, a fixed wing is mounted to the aircraft. An auxiliary wing is moveably coupled to the fixed wing and actuatable between a retracted position and an extended position. In the retracted position, the auxiliary wing is housed within the fixed wing and, in the extended position, the auxiliary wing is positioned above the fixed wing such that a venturi passageway is defined between the auxiliary wing and the fixed wing. A sail is deployable along a length of the auxiliary wing from a boom associated with the aircraft.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is side cross-sectional view of a prior art airfoil assembly having an airfoil connected in a leading edge embodiment;

FIG. 2 is a side cross-sectional view of a prior art airfoil assembly having an airfoil connected in a bottom surface embodiment;

FIG. 3 is a side cross-sectional view of a prior art airfoil assembly having an airfoil connected in an upper surface embodiment;

FIG. 4A is a front perspective view of one embodiment of an aircraft having a deployable airfoil assembly;

FIG. 4B is a front perspective view of the aircraft of FIG. 4A wherein the deployable airfoil assembly is in a fully deployed configuration;

FIG. 5 is a perspective view of one embodiment of a deployable airfoil assembly;

FIG. 6 is a top plan view of one embodiment of a depolyable airfoil assembly;

FIG. 7 is a perspective view, partly broken away, of one embodiment of the boom of FIG. 6 including the static support tube, rotatable drum, and pair of flexible sails;

FIG. 8A is a top plan view of one embodiment of an aircraft utilizing the deployable airfoil assembly in a fully retracted configuration;

FIG. 8B is a side view of the aircraft along line 8B-8B′ of FIG. 8A;

FIG. 8C is a top plan view of the aircraft utilizing the deployable airfoil assembly in a partially deployed configuration;

FIG. 8D is a side view of the aircraft along line 8D-8D′ of FIG. 8C;

FIG. 8E is a top plan view of the aircraft utilizing the deployable airfoil assembly in a fully deployed configuration;

FIG. 8F is a side view of the aircraft along line 8F-8F′ of FIG. 8E;

FIG. 9A is a front perspective view of another embodiment of an aircraft having a deployable airfoil assembly;

FIG. 9B is a front perspective view of the aircraft of FIG. 9A wherein the deployable airfoil assembly is in a fully deployed configuration;

FIG. 10A is a schematic illustration of one embodiment of an orbiting platform utilizing a depolyable airfoil assembly; and

FIG. 10B is a perspective view of the underside of the orbiting platform of FIG. 10A.

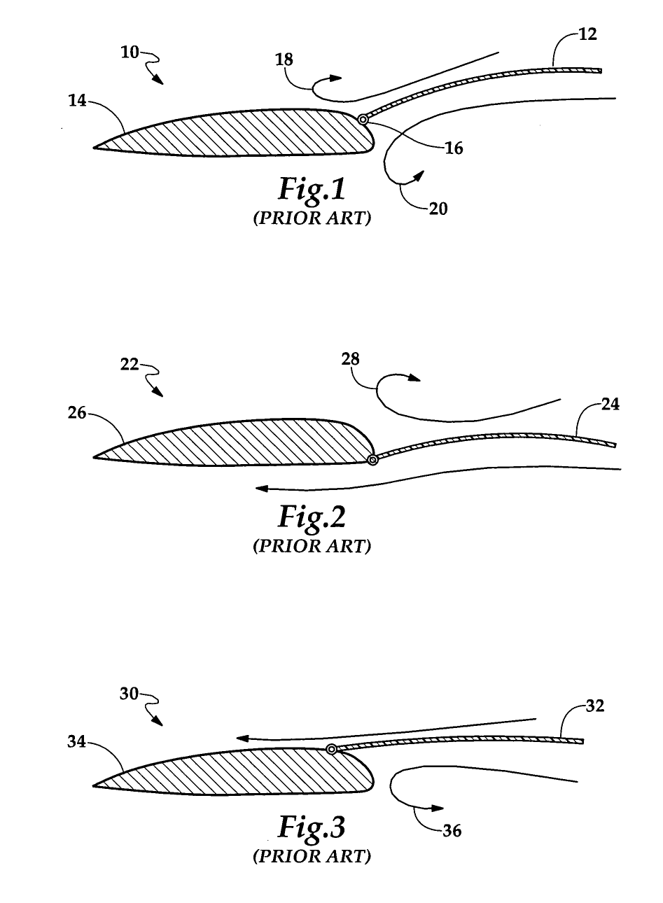

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

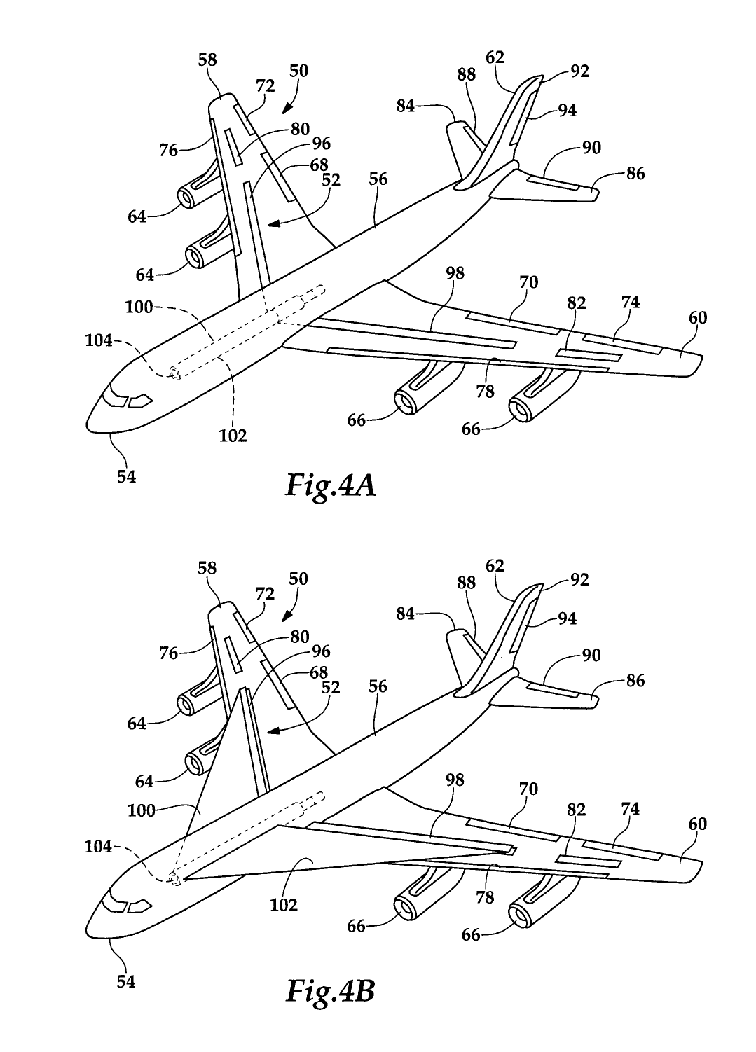

Referring initially to FIG. 4A, therein is depicted one embodiment of an aircraft 50 having a deployable airfoil assembly 52. The aircraft 50 includes a cockpit 54 that provides for command and control of the aircraft 50. A fuselage 56 carries the aircraft's payload and fuel and connects the cockpit 54 with fixed wings 58 and 60 and a tail assembly 62. As illustrated, jet engines 64 and 66 are positioned in pods under the fixed wings 58 and 60, respectively, to provide thrust for the aircraft 50. Flaps 68 and 70 are adjustable to alter lift and drag and ailerons 72 and 74 are adjustable to change roll. Additionally, slats 76 and 78 affect lift and spoilers 80 and 82 affect lift and drag. To control and maneuver the aircraft 50, the tail assembly 62 includes horizontal stabilizers 84 and 86 having elevators 88 and 90, respectively, to control pitch and a vertical stabilizer 92 having a rudder 94 to control yaw.

The deployable airfoil assembly 52 includes auxiliary wings 96 and 98 moveably coupled to the fixed wings 58 and 60, respectively, and actuatable between a retracted position and an extended position. As depicted, in the retracted position, the auxiliary wings 96 and 98 are housed within the fixed wings 58 and 60, which together may be referred to as an auxiliary wing structure. In particular, in one implementation, the auxiliary wings 96 and 98 are flush with the fixed wings 58 and 60 in order to create a continuous, aerodynamic wing and minimize the presence of drag. Dynamic wings or sails 100 and 102 are furled about a boom 104 that is associated with the aircraft 50 and positioned in the fuselage 56. It should be appreciated that for some types of aircraft a single furling boom or boom positioned in the center of the fuselage will not be appropriate. In these instances, two booms may be utilized such that one is positioned on each side of the fuselage proximate to each fixed wing.

FIG. 4B depicts the aircraft 50 of FIG. 4A in a fully deployed configuration. In the extended position, the auxiliary wings 96 and 98 are positioned above the fixed wings 58 and 60 such that a venturi passageway is defined between the auxiliary wings 96 and 98 and the fixed wings 58 and 60. Additionally, the sails 100 and 102 are deployed along a length of the auxiliary wings 96 and 98 from the boom 104. In addition to unwrapping the sails 100 and 102 from a furled or retracted position to an unfurled or extended position, the boom 104 returns the sails 100 and 102 from the unfurled to the furled position. As will be explained in further detail hereinbelow, the dynamic and auxiliary wing arrangement optimizes performance of the aircraft by eliminating stall zones and related drag. The deployable airfoil assembly presented herein is not heavy, however. It is relatively light, which is critical on weight sensitive, fully loaded aircraft.

More specifically, the retractable airfoil assembly constructed in accordance with the teachings presented herein provides significant flight benefits. When the auxiliary wings are fully extended and the sails are completely deployed, the wing area is increased, thereby resulting in increased lift. The increased lift enables the aircraft to takeoff at slower speeds without stalling. The slower speed requirements on takeoff translate into short landing rolls. Further, slower landing speeds result in less wear and tear on the undercarriage components, such as tires, landing gear, and struts, of the aircraft. Moreover, takeoff roll may be reduced since the aircraft can rotate at slower speed, thus reducing requirements for longer runways. This is particularly important as real estate demands force new airports to consider shorter runways. The aircraft is also able to climb at slower speeds and at greater climb angles. Such abilities are useful in noise sensitive areas or where the glide path adjacent the end of the runway is obstructed.

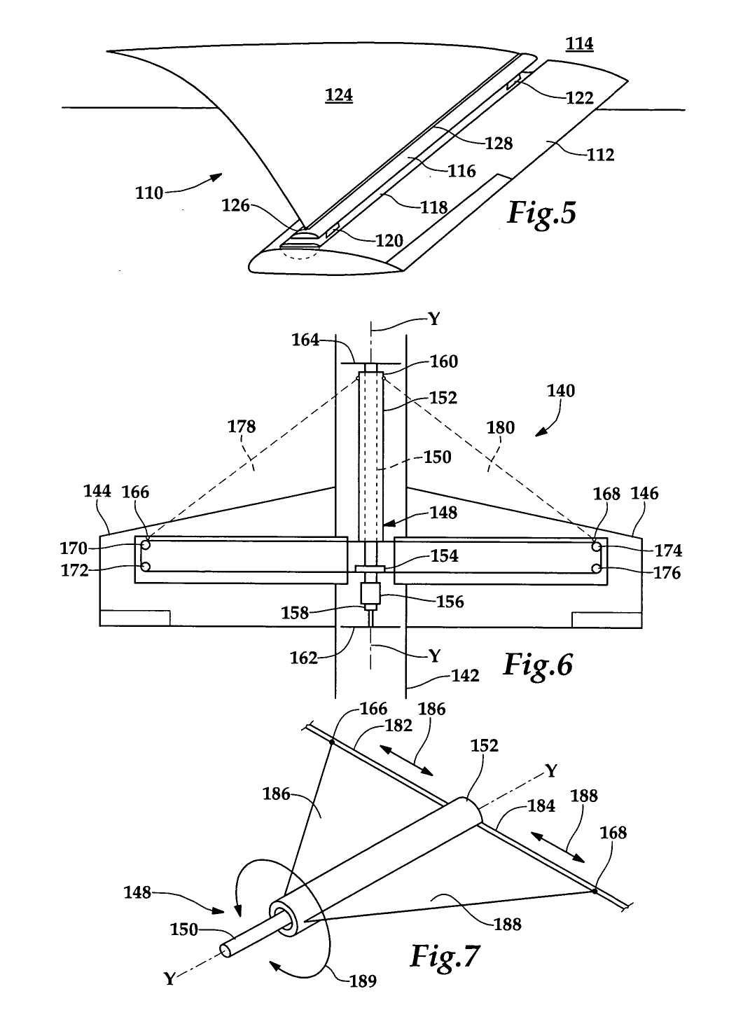

FIG. 5 depicts one embodiment of a deployable airfoil assembly 110 in a fully deployed configuration. A fixed wing 112 is coupled to a fuselage 114 of an aircraft. An auxiliary wing 116 is housed within a compartment or recess 118 of the fixed wing 112 and extendable therefrom by the actuation of pedestals 120 and 122. The auxiliary wing 116 may comprise aluminum or an aluminum alloy, for example. Once the auxiliary wing 116 is positioned, a sail 124 is deployed from the fuselage 114. The sail 124 may comprise a cloth fabric construction that is reinforced with MYLAR®, KEVLAR®, or nylon filaments, for example. A guide cable 126 which commutes laterally along trailing edge track 128 extends and retracts the sail 124 and maintains tension in the sail 124 during deployment and recovery. It should be appreciated that the edge track may be positioned at the trailing edge, leading edge or at an intermediate edge of the auxiliary wing.

It should be appreciated that although the sail 124 is illustrated as completely deployed, the deployable airfoil assembly described herein may be partially deployed in particular implementations. Regardless of whether the sails of the deployable airfoil assembly are partially or completely deployed, the deployable airfoil assembly selectively augments the surface area of an aircraft without creating stall zones or drag. In particular, the arrangement of both auxiliary wings and sails overcomes the limitations of '195 patent as presented in the Background hereinabove.

FIG. 6 depicts one embodiment of an aircraft 140 utilizing a depolyable airfoil assembly. The aircraft 140 includes a fuselage 142 and fixed wings 144 and 146. A boom 148 includes a static tube 150 concentrically mounted within an outer winding tube or furling drum 152. Additionally, the retractable airfoil assembly 140 includes a spring-biased cable drum 154, a drive motor 156, and bearings 158 and 160. An aft portion of the static tube 150 is attached at a connection 162 to the fuselage 142 or, in another embodiment, the base of the tail assembly. The forward portion of the static tube 150 is attached at a connection 164 to the fuselage 142 also or, in the another embodiment, a main wing spar of a fixed wing. In one embodiment, the furling drum 152 is tubular and is supported for rotation on the static tube 150 by the bearings 158 and 160. The static tube 150 provides stable support for the furling drum 152 and sails. The furling drum 152 is radially spaced from the static tube 150 and is rotatable clockwise and counterclockwise about the Y axis on the bearings 158 and 160.

The furling drum 152 is rotatably driven by the drive motor 156, which is located on a forward section of the static tube 150. It should be appreciated, however, that the drive motor 156 may be positioned in other locations. For example, the drive motor may be offset from the furling drum 152. In one implementation, the drive motor 156 is a reversible dc electric motor but may be driven by other means, for example, a hydraulic motor or pneumatic motor or manually by a hand crank.

Operating to provide a sail drive apparatus, opposite end portions of a drive cable are attached to and are wound around about the spring-biased cable drum 154. In addition to rotating the furling drum 152, the drive motor 156 also unreels the flexible drive cable from the spring-biased cable drum 154. The sail drive cable end portions are connected to the sails at cable connections 166 and 168, respectively, and maintain tension in the sails during retractions (furling) and extension (unfurling). The drive cable is guided around pulleys 170 and 172 that are located on the fixed wing 144 and pulleys 174 and 176 that are located on the fixed wing 146. In one implementation, as will be described in further detail hereinbelow, the drive cable is guided in tracks. The placement and number of pulleys utilized may change with different wing types. The drive cable arrangement may include a flexible heavy gauge cable or a chain with drive sprockets, for example. The flexible drive cable and spring-biased cable drum maintain tension in the sails during recovery and deployment. The tension applied by the drive cable maintains the sails in a flat airfoil configuration when the sails are extended. When unfurled, the sails occupy areas 178 and 180 to augment the surface area of the aircraft.

FIG. 7 depicts one embodiment of the boom 148 that further illustrates the static support tube 150 and rotatable drum 152 arrangement illustrated in FIG. 6. In particular, this figure further depicts guide tracks 182 and 184 that may be disposed along the auxiliary wing structures. Flexible sails 186 and 188 are movably coupled to the guide tracks 182 and 184 by cable connections 166 and 188, which move laterally through guide tracks 182 and 184 as illustrated by arrows 186 and 188, respectively. Further the flexible sails 186 and 188 are wrapped on over the other in overlapping relating around the furling drum 152. The sails 186 and 188 are unfurled from the furling drum 152 by clockwise or counterclockwise movement about the static support tube 150 as illustrated by arrow 189. Additional general details regarding track assemblies for guiding sails may be found in the following patent: U.S. Pat. No. 6,241,195 which issued in the name of Fred A. Wagner, III, which is hereby incorporated by reference for all purposes.

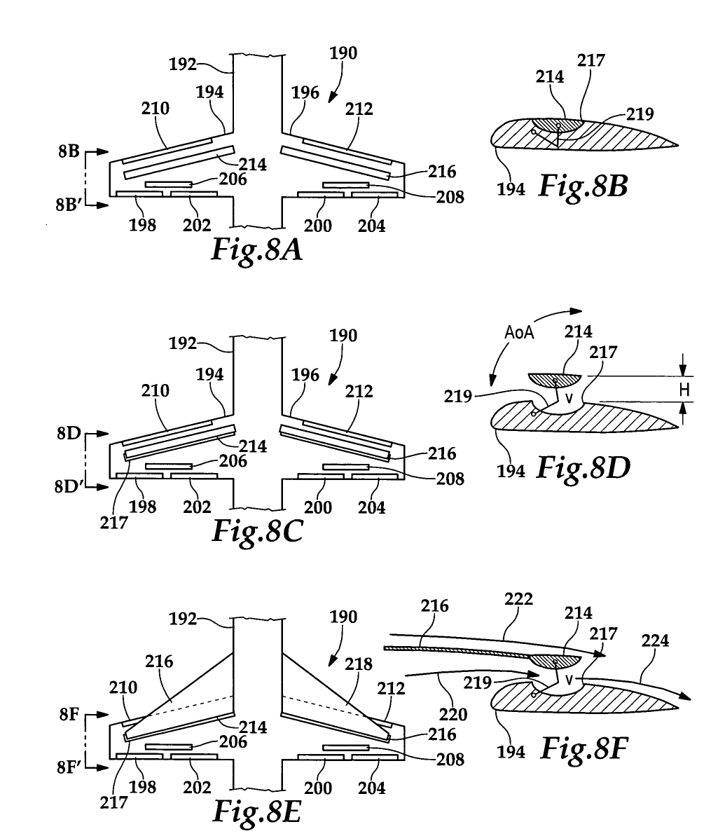

FIGS. 8A and 8B depict one embodiment of an aircraft 190 utilizing the deployable airfoil assembly described herein in a fully retracted configuration. The aircraft 190, which is only partially presented, includes a fuselage 192 and fixed wings 194 and 196 coupled thereto. The fixed wings 194 and 196 include ailerons 198 and 200, flaps 202 and 204, spoilers 206 and 208, and slats 210 and 212. Auxiliary wings 214 and 216 are in a retracted position and housed within recesses, such as recess 217, of the fixed wings 194 and 196. In one embodiment, the auxiliary wings 214 and 216 are placed slightly fore or aft of the point where the airflow separates on the upper surface of the fixed wing. As best seen in FIG. 8B, a scissor hinge 219 connects the auxiliary wing 214 to the fixed wing 194.

FIGS. 8C and 8D depict the aircraft utilizing the deployable airfoil assembly in a partially deployed configuration. As illustrated, hinges, such as the scissor hinge 219, actuate the auxiliary wings 214 and 216 from the retracted position to an extended position wherein the auxiliary wings 214 and 216 are positioned above the fixed wings 194 and 196, respectively, to create venturi passageways, such as venturi passageway V, between the auxiliary wings 214 and 216 and the fixed wings 194 and 196.

As best seen in FIG. 8D, the scissor hinge 219 permits the auxiliary wing 214 to be adjusted with respect to height H above the fixed wing 194 and angle of attack AoA. By changing the height H and angle of attack AoA of the auxiliary wing 214 the venturi passageway V may altered. It should be appreciated that height H and angle of attack AoA are adjusted and optimized in accordance with the drag and compressibility experienced at different velocities. In general, in order to maintain laminar airflow attached to the fixed wings, larger venturi passageways are required at slower speeds and narrower venturi passageways are required at higher speeds.

FIGS. 8E and 8F depict the aircraft 190 utilizing the deployable airfoil assembly in a fully deployed configuration. Sails 216 and 218 are deployed along lengths of the auxiliary wings 194 and 196, respectively, from a boom associated with the aircraft 190, thereby selectively augmenting the lift surface area of the aircraft 190. In one implementation, the thicknesses of the auxiliary wings 194 and 196 and the sails 216 and 218 are more similar than the thicknesses the auxiliary wings 194 and 196 and the fixed wings 194 and 196. In this implementation, the sails 216 and 218 compress and accelerate the airflow through the spaces, such as venturi V, defined between the fixed wings 194 and 196 and the auxiliary wings 214 and 216, respectively. By compressing and accelerating the airflow as depicted by arrows 220, 222, and 224, the sails 216 and 218 resemble guiding vanes that prevent the creation of stall zones and drag.

In operation, an aircraft may utilize the deployable airfoil assembly described herein during takeoff and landing. By way of example, the deployable airfoil assembly may be actuated before a takeoff sequence or before a landing sequence to augment the lift surface area of the aircraft and hold airflow to the wing to enable takeoff and landing operations at reduced speeds and with improved climbing rates. For example, when installed on a Cessna 172, the deployable airfoil assembly permits takeoff and landing operations at 20-30 knots (about 27-55 kilometers/hour) and a rate of climb of 1200 feet per minute (about 365 meters/minute) at full power and 700 feet per minute (about 213 meters/minute) at 65 percent power. Following the takeoff or landing sequence, the deployable airfoil assembly may be retracted and cradled in the recess to allow for high speed cruising.

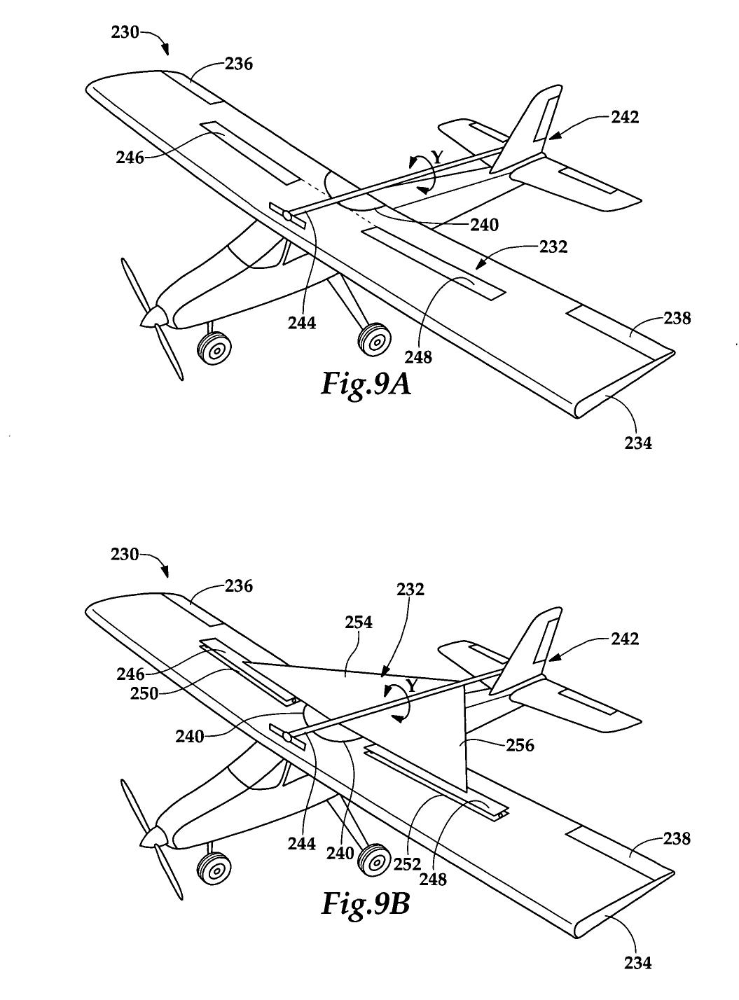

FIG. 9A depicts a high wing aircraft 230 having a deployable airfoil assembly 232 in a fully retracted, furled configuration according to a trailing edge embodiment. The retractable airfoil assembly 232 includes a fixed wing 234 having ailerons 236 and 238 and an aerodynamic fairing 240. The aircraft also includes a tail assembly 242. A forward end portion of a support boom 244 is mounted on the fixed wing at a main wing spar just aft of a leading edge of the fixed wing. A rear end portion of the support boom 244 is mounted on the base of the tail assembly 242. As previously described in FIG. 6, the support boom 244 includes a furling drum that is rotatable clockwise and counter clockwise about the Y axis (longitudinal). As depicted, in the retracted position, auxiliary wings 246 and 248 are housed within recesses of the fixed wing.

FIG. 9B depicts a front perspective view of the aircraft 230 of FIG. 9A wherein the deployable airfoil assembly 232 is in a fully deployed configuration. In the extended position, the auxiliary wings 246 and 248 are extended above recesses 250 and 252, respectively, and positioned above the fixed wing 234 such that a venturi passageway is defined between the auxiliary wings 246 and 248 and the fixed wing 234. Additionally, the sails 254 and 256 are deployed along a length of the auxiliary wings 246 and 248 from the support boom 244. As previously discussed, the height and angle of attack of the auxiliary wings may be adjusted in order to manipulate the venturi in response to a changing velocity or other flight requirements.

The sail 254 runs aft of the right side of the trailing edge from the auxiliary wing to the support boom 244 and extends diagonally aft to the base of the tail assembly 242. Sail 256 is constructed in a mirror relationship. It should be appreciated that the deployable airfoil assembly described herein may be utilized in different configurations with a variety of aircrafts. By way of further example, the deployable airfoil assembly described herein may be utilized with a turbine-powered airliner as illustrated in FIGS. 4A and 4B, a high wing aircraft as illustrated in FIGS. 9A and 9B, and other types of aircraft including small and mid-sized aircraft manufactured by Cessna, corporate aircraft manufactured by Gulfstream Aerospace, or commercial aircraft manufactured by Boeing or Airbus, for example.

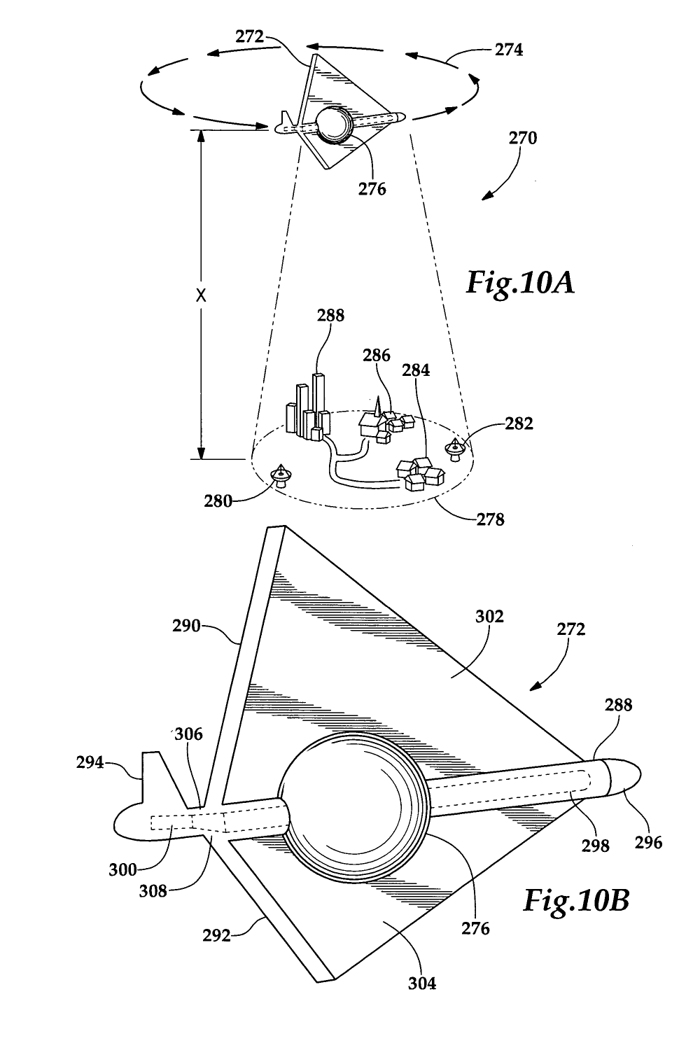

FIG. 10A depicts one embodiment of an orbiting platform 270 utilizing a depolyable airfoil assembly 272. The orbiting platform 270, which may be a “drone”, is in a controlled or pseudo-stationary position while orbiting along a path depicted by arrows 273 at an altitude x above the ground 274. Preferably, the orbiting platform 270 is at a high altitude. For example, in one implementation, the orbiting platform 270 is at an altitude between 60,000 and 100,000 feet (18,288 and 30,480 meters).

Equipment 276 is coupled to the under-side of the orbiting platform 270 such that the equipment 276 is facing ground 274 and, in particular, region 275 which includes a remote communications station 280, a city 282, and towns 284 and 286. As illustrated, the equipment 276 is communications equipment that is relaying communications signals between the remote communications station 280, the city 282, and the towns 284 and 286.

It should be appreciated, however, that the equipment 276 may be other types of communications equipment, navigation equipment, or remote sensing equipment, for example. By way of further example, the communications equipment and navigation equipment may be suitable for personal communications, data messaging, direct broadcasting, and particular mobile applications where users require primarily regional coverage. The remote sensing equipment may be suitable for high resolution imaging, regional public services for agriculture, hydrology, fire protection, traffic monitoring, or disaster relief support, for example.

Referring now to FIG. 10B, the orbiting platform 270 includes a deployable airfoil assembly 272 for selectively augmenting lift surface area of the orbiting platform 270. A fuselage 288 includes wings 290 and 292 connected thereto. In one implementation, the fuselage 288 and the wings 290 and 292 form a T-frame wherein the wings 290 and 292 are of a similar thickness to the deployed sails so that lift and flight are not adversely affected. In an alternative embodiment, the orbiting platform is outfitted with the auxiliary wing arrangement discussed in detail hereinabove. As previously discussed, the equipment 276 is coupled to the fuselage 288. The illustrated configuration, where the orbiting platform includes equipment 276, is ideal for applications where the unique combination of altitude and controlled position over a certain area provides significant advantages over both terrestrial and space systems.

A boom 298 having the sails wrapped therearound is positioned within the fuselage 288. A vertical stabilizer 294 is positioned at the rear of the orbiting platform 270 and control equipment is positioned in a nose 296 of the orbiting platform 270, which is unmanned in a preferred embodiment. Additional control and mechanical equipment including a fuel supply (e.g., batteries or gasoline) is positioned in the aft of the orbiting platform 270 as indicated by numeral 300. Additionally, landing gear and rolling gear may be appropriately positioned in the fuselage 298. It should be appreciated that other control and mechanical equipment arrangements are within the teachings of the present invention.

Guide tracks 302 and 304 are positioned along the wings 290 and 292, respectively. Sails 306 and 308 are deployed from the boom 298 along the guide tracks 302 and 304 in a manner similar to that discussed in detail in FIGS. 5-7. More specifically, the sails 306 and 308 are deployable and retractable to meet the immediate needs of the orbiting platform 270. During flight at high altitudes, the depolyable sails of the present invention provide great amounts of wing area to ensure enough lift at the slow air speeds (e.g., 17 to 25 knots or 31 to 46 kilometers/hour) associated with controlled or pseudo-stationary positions. When ascending or descending through turbulent air, the depolyable sails may be partially or completely retracted as required. Further, when grounded, the deployable sails are retracted to provide for ease of handling. To provide for further ease of ground handling, the wings 290 and 292 are not necessarily fixed. The wings may be retractable at joints 310 and 312.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A deployable airfoil assembly for selectively augmenting lift surface area of an aircraft, comprising:
a fixed wing mounted to the aircraft;
an auxiliary wing moveably coupled to the fixed wing and actuatable between a retracted position and an extended position, in the retracted position, the auxiliary wing being housed within the fixed wing and, in the extended position, the auxiliary wing being positioned above the fixed wing such that a venturi passageway is defined between the auxiliary wing and the fixed wing; and
a sail deployable along a length of the auxiliary wing from a boom associated with the aircraft.

2. The deployable airfoil assembly as recited in claim 1, wherein the auxiliary wing further comprises a recess operable to accommodate the auxiliary wing in the retracted position.

3. The deployable airfoil assembly as recited in claim 1, further comprising a set of hinges that moveably couples the auxiliary wing to the fixed wing, the set of hinges for actuating the auxiliary wing between the retracted and extended positions.

4. The deployable airfoil assembly as recited in claim 1, further comprising a pedestal that moveably couples the auxiliary wing to the fixed wing, the pedestal for actuating the auxiliary wing between the retracted and extended positions.

5. The deployable airfoil assembly as recited in claim 1, wherein the auxiliary wing is adjustable with respect to height.

6. The deployable airfoil assembly as recited in claim 1, wherein the auxiliary wing is adjustable with respect to angle of attack.

7. A method for selectively augmenting lift surface area of an aircraft, the method comprising:
housing an auxiliary wing in a retracted position in a recesses of a fixed wing, the fixed wing being mounted to the aircraft;
actuating the auxiliary wing from the retracted position to an extended position above the fixed wing to create a venturi passageway between the auxiliary wing and the fixed wing; and
deploying a sail along a length of the auxiliary wing from a boom associated with the aircraft, thereby selectively augmenting the lift surface area of the aircraft.

8. The method as recited in claim 7, further comprising initiating a takeoff sequence upon the deployment of the sail.

9. The method as recited in claim 7, further comprising initiating a landing sequence upon the deployment of the sail.

10. The method as recited in claim 7, further comprising adjusting the venturi passageway by changing the angle of attack associated with the auxiliary wing.

11. The method as recited in claim 7, further comprising adjusting the venturi passageway by changing the height associated with the auxiliary wing.

12. The method as recited in claim 7, further comprising, following a takeoff sequence:
retracting the sail into the boom; and
actuating the auxiliary wing from the extended position to the retracted position.

13. The method as recited in claim 7, further comprising, following a landing sequence:
retracting the sail into the boom; and
actuating the auxiliary wing from the extended position to the retracted position.

14. A system for selectively augmenting lift surface area of an aircraft, the system comprising:
a fixed wing mounted to the aircraft, the fixed wing having a recess for housing an auxiliary wing in a retracted position;
means for actuating the auxiliary wing from the retracted position to an extended position above the fixed wing to create a venturi passageway between the auxiliary wing and the fixed wing; and
means for deploying a sail along a length of the auxiliary wing from a boom associated with the aircraft.

15. The system as recited in claim 14, wherein the aircraft initiates a takeoff sequence upon the deployment of the sail.

16. The system as recited in claim 14, wherein the aircraft initiates a landing sequence upon the deployment of the sail.

17. The system as recited in claim 14, wherein the venturi passageway is adjusted by changing the angle of attack associated with the auxiliary wing.

18. The system as recited in claim 14, wherein the venturi passageway is adjusted by changing the height associated with the auxiliary wing.

19. The system as recited in claim 14, wherein the aircraft, following completion of a takeoff sequence, retracts the sail into the boom and actuates the auxiliary wing from the extended position to the retracted position.

20. The system as recited in claim 14, wherein the aircraft, following completion of a landing sequence, retracts the sail into the boom and actuates the auxiliary wing from the extended position to the retracted position.

21. A deployable airfoil assembly for selectively augmenting lift surface area of an aircraft of the type including a fixed wing structure comprising:
a furling drum mounted on the aircraft for rotation about a longitudinal axis;
an auxiliary wing structure moveable coupled to the fixed wing structure and actuatable between a retracted position and an extended position, in the retracted position, the auxiliary wing structure being housed within the fixed wing structure and, in the extended position, the auxiliary wing structure being positioned above the fixed wing structure such that a venturi passageway is defined between the auxiliary wing structure and the fixed wing structure;
a guide track disposed along the auxiliary wing structure;
first and second flexible sails movably coupled to the guide track and wrapped on over the other in overlapping relation around the furling drum; and
a sail drive apparatus attached to the sails for moving the sails along the guide tracks.

22. The assembly as recited in claim 21, wherein the sail drive apparatus comprises a rotatable cable drum and a drive cable would about the retractable cable drum, the drive cable including a first end portion and a second end portion attached to the first sail and the second sail, respectively.

23. The assembly as recited in claim 21, further comprising a rotary drive motor in mechanical communication with the furling drum for rotating it clockwise and counterclockwise.

24. A deployable airfoil assembly for selectively augmenting lift surface area of an orbiting platform, comprising:
a fuselage;
first and second wings coupled to the fuselage;
first and second guide tracks positioned along the first and second wings respectively; and
first and second sails deployable along the first and second guide tracks, the first and second sails being deployed from a boom associated with the aircraft.

25. The deployable airfoil assembly as recited in claim 24, further comprising equipment mounted to the fuselage, the equipment being selected from the group consisting of communications equipment, navigation equipment, and remote sensing equipment.

26. The deployable airfoil assembly as recited in claim 24, wherein the first and second wings are retractable for storage.
